(19) United States
(12) Patent Application Publication
(10) Pub. No.: US 2018/0178997 A1
(43) Pub. Date: Jun. 28, 2018

(54) VEHICLE FLOOR AND TROLLEY ASSEMBLY

(71) Applicant: David Burrell, Crows Nest (AU)

(72) Inventor: David Burrell, Crows Nest (AU)

(21) Appl. No.: 15/851,527

(22) Filed: Dec. 21, 2017

(30) Foreign Application Priority Data
Dec. 22, 2016 (AU) 2016905315

(51) Int. Cl. B65G 67/02; B60R 9/06

(52) U.S. Cl. CPC B65G 67/02; B60R 9/06

(57) ABSTRACT

A load receiving area (10) of a motor vehicle, such as a utility, a vehicle with a load receiving tray or motor lorry. The vehicle has a platform or tray (13) that supports a sheet member (14) that has a pair of longitudinally extending tracks (19) and transverse tracks (20), that receive and guide a trolley (22).

### FIELD

The present invention relates to vehicle floor systems, and trolleys that are received on the vehicle floor systems.

### BACKGROUND

Many motor vehicles are provided with a rear load receiving tray, upon which a load is supported. It is known to have trolleys, and other wheeled articles, received on the vehicle tray and movable therealong for the purposes of loading and unloading.

A disadvantage of previous vehicle floors is that the load receiving area forward and rearward of the wheel arches is frequently unusual, since the trolleys need to move forward and rearward. The wheel arches preventing movement in the areas forward and rearward of the wheel arches.

### OBJECT

It is the object of the present invention to overcome or substantially ameliorate the above disadvantage.

### SUMMARY OF INVENTION

There is disclosed herein a load support member for a load receiving area of a motor vehicle, the member includes at least one track to extend longitudinally in a forward direction of movement of the vehicle, and at least one transverse track to extend transverse of said direction, the tracks intercepting and configured to engage a trolley to direct a trolley longitudinally of the load receiving area and transverse of the load receiving area.

Preferably, the member is a sheet member, with the vehicle having a floor upon which the sheet member rests.

Preferably, the sheet member includes a recess through a vehicle wheel arch may project.

Preferably, the transverse track is a first transverse track, and the member includes a second transverse track, the second transverse track intersecting with the longitudinal track but spaced longitudinally of the longitudinal track from the first transverse track, with the recess located between the first and the second transverse tracks.

Preferably, the longitudinal track is a first longitudinal track, and the member includes a second longitudinal track, the second longitudinal track being spaced from the first longitudinal track in a direction transverse of said direction, with the member including a further transverse track extending from the second longitudinal track in an opposite direction relative to each track intersecting with the first longitudinal track.

Preferably, the member includes a still further transverse track, the still further transverse track being located so as to extend from the second longitudinal track and spaced from the further transverse track so that respective recesses in the member through which a vehicle wheel arm may project is located between the forward transverse track and the still further transverse track.

Preferably, the member is formed of high density polyethylene.

Preferably, the sheet member includes a first sub-sheet member and a second sub-sheet member, the first sub-sheet member having the first longitudinal track and the second sub-sheet member having the second longitudinal track.

There is further disclosed herein a trolley to be mounted on a vehicle load receiving area, the trolley including:

a base that is to receive and support a load;

a first frame attached to the base and moved relative thereto between a raised retracted position and a lowered position;

a second frame, the second frame being attached to the base and movable relative thereto between a raised retracted position and a lowered position;

at least one wheel attached to each frame and extending therefrom so that when the frames are in the lowered position, the wheels engage a supporting surface so that the trolley is supported on the supporting surface for movement therealong; and wherein

the base includes a floor with a recess into which a wheel arch of the vehicle can protrude so that the trolley can be at least partly located forward of the wheel arch, and at least partly rearward of the wheel arch.

Preferably, the trolley includes a projection to engage a track of the load receiving area to guide the trolley in longitudinal and transverse movement relative to the vehicle.

Preferably, the trolley includes at least one further wheel, each further wheel being provided to engage the supporting surface when the frames are in the retracted position.

### BRIEF DESCRIPTION OF DRAWINGS

Preferred forms of the present invention will now be described by way of example with reference to the accompanying drawings wherein:

FIG. 1 is a schematic isometric view of the load receiving area of a motor vehicle;

FIG. 2 is a schematic parts exploded isometric view of the load receiving area of FIG. 1;

FIG. 3 is a schematic enlarged view of the portion 3 of FIG. 1;

FIG. 4 is a schematic side elevation of the load receiving area of FIG. 1;

FIG. 5 is a schematic top plan view of the load receiving area as shown in FIG. 4;

FIG. 6 is a schematic sectioned plan view of the load receiving area of FIG. 4 sectioned along the line 6-6;

FIG. 7 is a schematic enlarged view of the portion 7 of FIG. 5;

FIG. 8 is a schematic enlarged view of the portion 8 of FIG. 5; and

FIG. 9 is a schematic parts exploded isometric view of a trolley to be employed with the load receiving area of FIG. 1.

### DESCRIPTION OF EMBODIMENTS

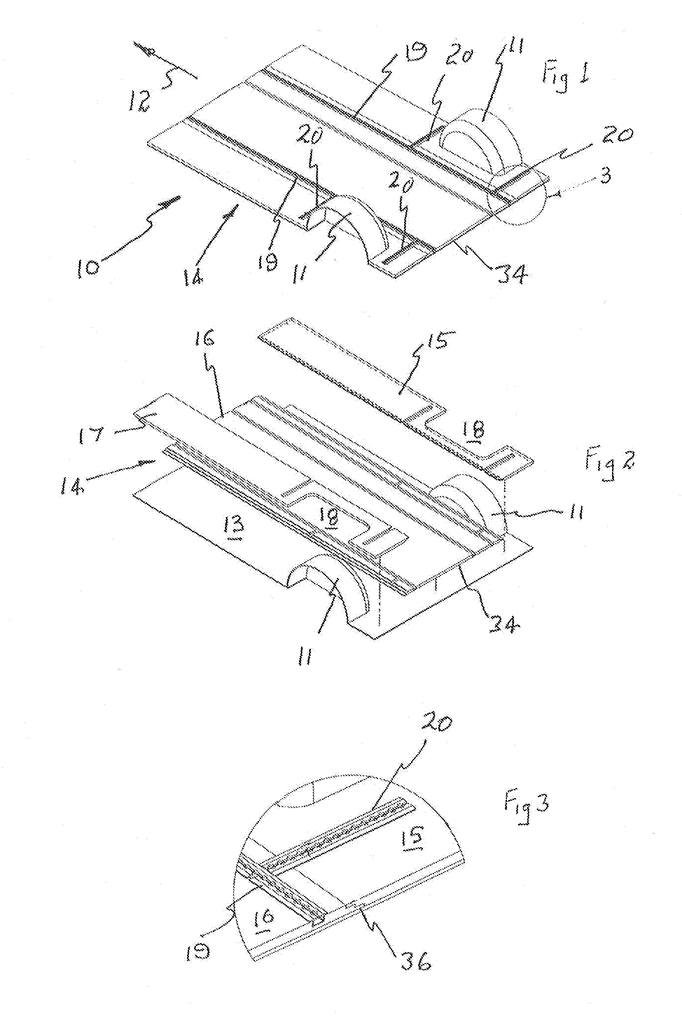

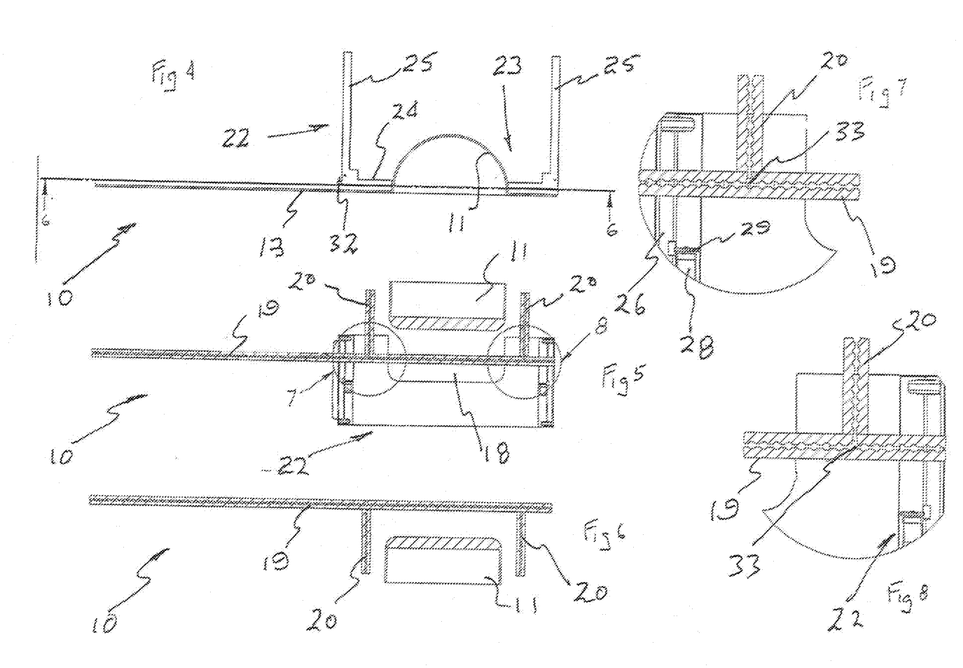

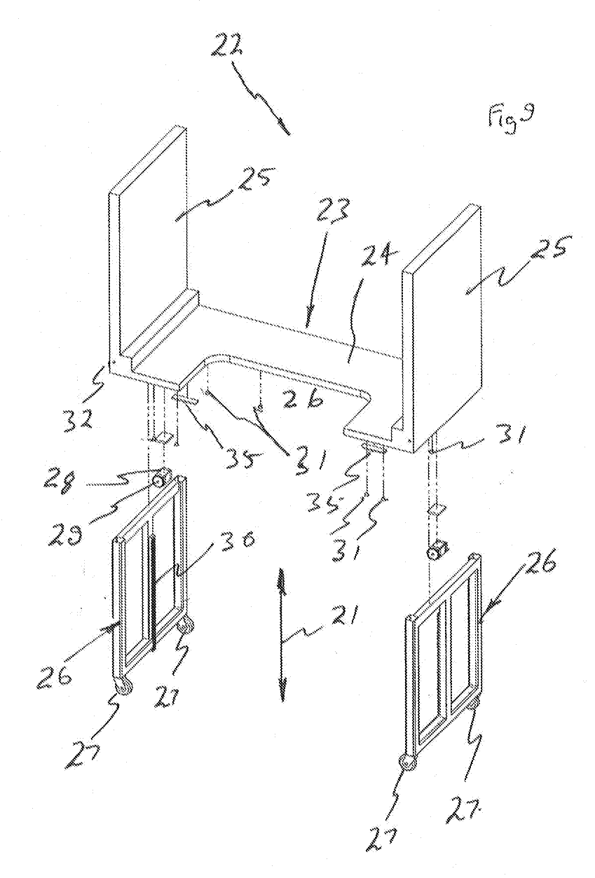

In FIGS. 1 to 8 there is schematically depicted the load receiving area 10 of a motor vehicle, such as a utility, a vehicle with a load receiving tray or a motor lorry.

The motor vehicle has a platform or tray 13 that supports a load, with wheel arches 11 projecting upwardly therefrom. The vehicle is intended to have a forward travel direction 12.

Supported on the tray 13 is a support member, in the form of a sheet 14 (load support member). Preferably, the sheet 14 is formed of flexible material, such as plastic material, and most preferably is formed of high density of polypropylene.

The sheet 14 of this embodiment has three sub-sheets 15, 16 and 17. The sub-sheet 16 is located generally centrally between the wheel arches 11, while sub-sheets 15 and 17 are located so as to be adjacent the wheel arches 11. The sub-sheet 16 is located between the sub-sheets 15 and 17.

Preferably, the sub-sheets 15, 16 and 17 are co-extensive and extend generally parallel to the direction 12. Preferably the sub-sheets 15, 16 and 17 have edge portions 19 that are stepped so that the sub-sheets 15 and 17 partly project above the sub-sheet 16 at the edge portions 36.

The sheet 14 is provided with a pair of longitudinally extending tracks 19, that are parallel and co-extensive. Most preferably the tracks 19 are provided by the sub-sheet 16. Additionally, the tracks 19 extend longitudinally in the direction 12.

Also provided are transverse tracks 20 that intercept with the tracks 19 and extend generally perpendicular relative to the longitudinal direction of extension of the tracks 19 and therefore the direction 12. Most preferably the tracks 20 have their major length in the sub-sheets 15 and 17, with a small proportion of their length provided by the sub-sheet 16, and extending from the tracks 19.

Most preferably, the tracks 19 and 20 are formed of metal and most preferably and aluminium extrusions.

The area 10 is intended to receive and support a plurality of trolleys. Some trolleys may be supported on the sub-sheet 16, while other trolleys may be supported on the sub-sheets 15 and 17. In particular, the trolleys would include one or more trolleys 22 as shown in FIG. 9. The trolley 22 of FIG. 9 is intended to be located adjacent the wheel arch 11 on the left hand side of the vehicle. The trolley 22 can also be located adjacent the other wheel arch 11.

The trolley 22 includes a base 23 that is intended to receive and support a load. The base 23 includes a floor 24 and end walls 25 between which the floor 24 extends. The floor 24 has a recess 26 through which the associated wheel arch 11 would project.

Preferably each end wall 25 is hollow and slidably receives an associated frame 26, with the frames 26 being movable in the direction 27 between a raised position at least substantially located within the associated end wall 12, and a lowered extended position at which the frames 26 project below the floor 24.

Each frame 26 is provided with wheels 27 that may be castor wheels.

Mounted in each end wall 25 is an electric motor 28 that rotatably drives a pinion 29, with each pinion 29 meshingly engaged with a rack gear 30 fixed to a respective frame 26, so that upon activation of the motor 28, the pinion 29, via engagement with its associated rack 30, causes movement of the associated frame 26 in the direction 21. That is, by activating the motor 28 the frames 26 can be raised and lowered, that is moved between their extended and retracted positions.

In the extended position, the trolley 22 is supported on the wheels 27.

The trolley 22 is also provided with a plurality of further wheels 31 that are spherical elements captively located with respect to the floor 24 but projecting below the floor 24 so that when the wheels 27 are retracted, the trolley 22 is supported on the wheels 31.

The trolley 22 also includes a projection or pin 32 that projects lower than the floor 24.

Each track 19 is provided with one or more recesses 33 to be engaged by the pin 32 to retain the trolley 22 in the position required.

In use of the above trolley 22, in loading the trolley 22 on the sheet 14, the trolley 22 is supported on the wheels 27 and moved towards the rear edge 34 of the tray 13 and sheet 14. At this time, the forward edge of the trolley 22 projects above the sheet 14 so that the forward wheels 31 are located above the sheet 14. At this time, the forward frame 26 is moved to the retracted position, so that the forward edge of the tray 22 is now supported on the wheels 31. The trolley 22 is then moved forward in the direction 12 until the rear frame 26 is located adjacent the edge 34.

The trolley 22 also includes a pair of track following projections 35 that are engaged in a respective one of the tracks 19 to guide the trolley 22 in its direction 12. The trolley 22 is moved in the direction 12 and engaged with the track 19 until the projections 35 are aligned with one of the transverse tracks 20. At that time, the trolley 22 is moved laterally so that the projections 35 travel along the engaged tracks 20. The trolley 22 will then be positioned so that the wheel arch 11 projects through the recess 26.

The pin 32 is then moved downward so as to engage the recess 33 to secure the trolley 22 in position.

1.-17. (canceled)

18. A load support member for a load receiving area of a motor vehicle, the member includes at least one track to extend longitudinally in a forward direction of movement of the vehicle, and at least one transverse track to extend transverse of said direction, the tracks intercepting and configured to engage a trolley to direct a trolley longitudinally of the load receiving area and transverse of the load receiving area.

19. The load support member of claim 18, wherein the member is a sheet member, with the vehicle having a floor upon which the sheet member rests.

20. The load support member of claim 19, wherein the sheet member includes a recess through a vehicle wheel arch may project.

21. The load support member of claim 20, wherein the transverse track is a first transverse track, and the member includes a second transverse track, the second transverse track intersecting with the longitudinal track but spaced longitudinally of the longitudinal track from the first transverse track, with the recess located between the first and the second transverse tracks.

22. The load support member of claim 18, wherein the longitudinal track is a first longitudinal track, and the member includes a second longitudinal track, the second longitudinal track being spaced from the first longitudinal track in a direction transverse of said direction, with the member including a further transverse track extending from the second longitudinal track in an opposite direction relative to each track intersecting with the first longitudinal track.

23. The load support member of claim 22, including a still further transverse track, the still further transverse track being located so as to extend from the second longitudinal track and spaced from the further transverse track so that respective recesses in the member through which a vehicle wheel arm may project is located between the forward transverse track and the still further transverse track.

24. The load support member of claim 18, wherein the member is formed of high density polyethylene.

25. The load support member of claim 22, wherein the sheet member includes a first sub-sheet member and a second sub-sheet member, the first sub-sheet member having the first longitudinal track and the second sub-sheet member having the second longitudinal track.

26. A trolley to be mounted on a vehicle load receiving area, the trolley including:
a base that is to receive and support a load;
a first frame attached to the base and moved relative thereto between a raised retracted position and a lowered position;
a second frame, the second frame being attached to the base and movable relative thereto between a raised retracted position and a lowered position;
at least one wheel attached to each frame and extending therefrom so that when the frames are in the lowered position, the wheels engage a supporting surface so that the trolley is supported on the supporting surface for movement therealong; and wherein
the base includes a floor with a recess into which a wheel arch of the vehicle can protrude so that the trolley can be at least partly located forward of the wheel arch, and at least partly rearward of the wheel arch.

27. The trolley of claim 26, further including a projection to engage a track of the load receiving area to guide the trolley in longitudinal and transverse movement relative to the vehicle.

28. The trolley of claim 26, further including at least one further wheel, each further wheel being provided to engage the supporting surface when the frames are in the retracted position.

29. The load support member of claim 21, wherein the longitudinal track is a first longitudinal track, and the member includes a second longitudinal track, the second longitudinal track being spaced from the first longitudinal track in a direction transverse of said direction, with the member including a further transverse track extending from the second longitudinal track in an opposite direction relative to each track intersecting with the first longitudinal track.

30. The load support member of claim 29, including a still further transverse track, the still further transverse track being located so as to extend from the second longitudinal track and spaced from the further transverse track so that respective recesses in the member through which a vehicle wheel arm may project is located between the forward transverse track and the still further transverse track.

31. The load support member of claim 22, wherein the member is formed of high density polyethylene.

32. The load support member of claim 23, wherein the sheet member includes a first sub-sheet member and a second sub-sheet member, the first sub-sheet member having the first longitudinal track and the second sub-sheet member having the second longitudinal track.

33. The trolley of claim 27, further including at least one further wheel, each further wheel being provided to engage the supporting surface when the frames are in the retracted position.

34. The load support member of claim 23, wherein the member is formed of high density polyethylene.
